(19) United States
(12) Patent Application Publication
(10) Pub. No.: US 2007/0104589 A1
(43) Pub. Date: May 10, 2007

(54) Delivery unit that is mounted in a fuel tank

(76) Inventor: Peter Marx, Wasbuttel (DE)

Correspondence Address: MAYER, BROWN, ROWE & MAW LLP, P.O. BOX 2828, CHICAGO, IL, 60690-2828, US

(21) Appl. No.: 10/561,138

(22) PCT Filed: May 27, 2004
(86) PCT No.: PCT/EP04/50947

§ 371 Date: Dec. 16, 2005

(30) Foreign Application Priority Data
Jun. 17, 2003 (DE) 10327523.1

(51) Int. Cl. F04B 23/08; F02M 37/00

(52) U.S. Cl. 417/87; 123/514

(57) ABSTRACT

The invention relates to a delivery unit comprising a vertical ejector. A deviation, which is manufactured in one piece with the cover of a fuel pump, is located above the outlet of a mixing tube. The delivery unit is thus extremely cost-effective to produce.

### BACKGROUND OF THE INVENTION

The invention relates to a delivery unit that is mounted in a fuel tank, with a fuel pump arranged in a baffle and with an ejector for delivering fuel into the baffle, a mixing tube of the ejector being arranged essentially vertically.

Delivery units of this type are frequently used in motor vehicles nowadays and are known from practice. The ejector is as a rule supplied with working fluid by the fuel pump and sucks up fuel from that region of the fuel tank which is situated outside the baffle. This ensures that the baffle is continuously filled with fuel. The vertical installation position of the ejector permits the use of a particularly long mixing tube.

The invention is based on the problem of designing a delivery unit of the type mentioned at the beginning in such a manner that it reliably avoids a squirting of the fuel delivered by the ejector out of the baffle.

### SUMMARY OF THE INVENTION

This problem is solved according to the invention in that a deviation for guiding the fuel delivered by the ejector into the baffle is arranged at the outlet of the mixing tube of the ejector.

By means of this design, the fuel delivered by the ejector passes toward the deviation after exiting from the mixing tube. Since the deviation directs the delivered fuel into the baffle, a squirting of the fuel out of the baffle is reliably avoided. As a result, the mixing tube can extend virtually as far as the upper boundary of the baffle. In this case, the deviation of the delivered fuel is independent of the delivery power of the ejector. The ejector can therefore have a particularly high delivery power.

According to an advantageous development of the invention, the deviation turns out to be particularly simple structurally if it has a curve, one partial region of the curve covering the opening of the mixing tube and another partial region being arranged above the baffle.

In the case of a particularly high delivery power of the ejector, the fuel can be guided, distributed over a large region, into the baffle and, in the process, high flow speeds can be avoided if the deviation has two curves adjacent to each other, the curves in their regions adjacent to each other being arranged above the mixing tube and the free ends of the curves protruding laterally over the mixing tube.

The delivery unit according to the invention turns out to be particularly simple structurally if the deviation is arranged on the baffle. In order to ensure a simple axial removal of the baffle from an injection mold, the deviation could be produced, for example, by deforming the wall of the baffle.

A deformation of the wall of the baffle or its complicated manufacturing can be avoided in a simple manner, according to another advantageous development of the invention, if the deviation is arranged on the fuel pump. By this means, the baffle can be manufactured as an injection molded part which can easily be removed from the mold axially.

The delivery unit according to the invention can thus be manufactured particularly cost-effectively.

According to another advantageous development of the invention, the installation of the deviation turns out to be particularly simple if the deviation is designed as a separate component which is to be fastened to the fuel pump or to the baffle.

The installation of the deviation is further simplified, according to another advantageous development of the invention, if the deviation forms a constructional unit with a component of the fuel pump. The component is preferably a cover carrying contacts for the electric motor. Since the cover, as a rule, is designed in any case as a component which is to be fitted separately, the deviation is fitted at the same time as the installation of the fuel pump.

The manufacturing costs of the delivery unit according to the invention are further reduced if the deviation is manufactured in one piece with the component of the fuel pump.

The mixing tube of the ejector could be manufactured integrally with the baffle. However, the installation of the delivery unit according to the invention is further simplified if the mixing tube of the ejector is designed together with the delivery pump as a constructional unit which can be preassembled. In the simplest case, the mixing tube can be designed integrally with the fuel pump.

### BRIEF DESCRIPTION OF THE DRAWINGS

The invention permits numerous embodiments. To further clarify its basic principle, two of these are illustrated in the drawing and are described below. In the drawing:

FIG. 1 diagrammatically shows a delivery unit according to the invention arranged in a fuel tank;

FIG. 2 shows a sectional illustration through a deviation of the delivery unit according to the invention from FIG. 1, along line II-II; and

FIG. 3 shows a further embodiment of the delivery unit according to the invention.

### DETAILED DESCRIPTION OF THE PREFERRED EMBODIMENTS

FIG. 1 shows diagrammatically a partial region of a fuel tank 1 with a flange 2 inserted in an opening. A delivery unit 3 with a fuel pump 5 which is fastened in a baffle 4 is arranged below the flange 2. The fuel pump 5 is driven by an electric motor 6 and delivers fuel from the baffle 4 into a forward-flow line 7 leading through the flange 2. The forward-flow line 7 is connected to an internal combustion engine (not illustrated) of a motor vehicle. The baffle 4 is filled with fuel via an ejector 8. The ejector 8 sucks up fuel via an opening 9 in the wall of the baffle 4 and delivers it via a vertical mixing tube 10 to a deviation 11. The ejector 8 is connected to the forward-flow line 7 via a working-fluid line 12. The deviation 11 is connected in one piece to a cover 13 of the fuel pump 5. Contacts 14 for contacting the electric motor 6 are arranged in the cover 13.

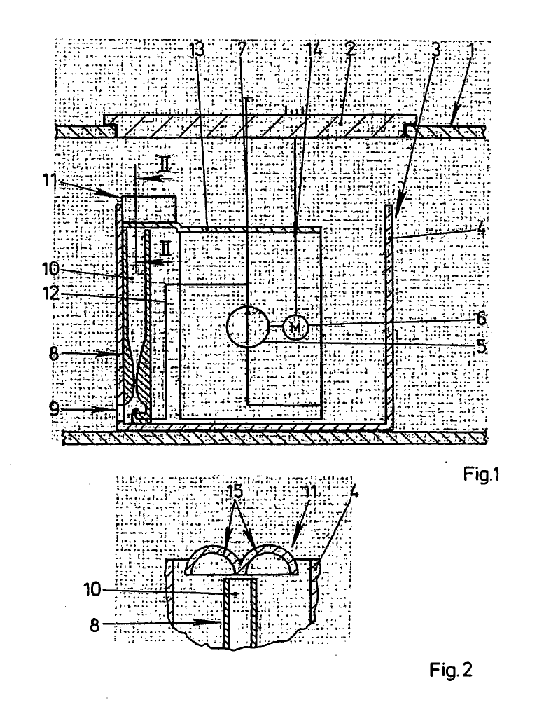

FIG. 2 shows, in a sectional illustration through the deviation 11 and the ejector 8 from FIG. 1, along line II-II, that the deviation 11 has two curves 15. The curves 15 are arranged in their regions adjacent to each other directly above the mixing tube 10 and extend in the region to the side of the mixing tube 10. By this means, fuel delivered by the ejector 8 from the mixing tube 10 first of all passes towards the deviation 11. The deviation 11 directs the delivered fuel into the baffle 4.

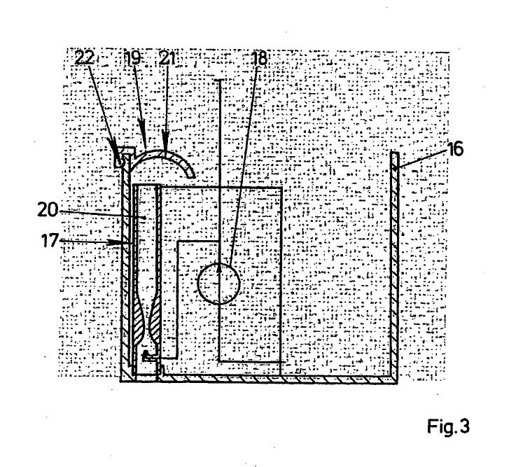

FIG. 3 shows a further embodiment of the delivery unit, in which a constructional unit comprising ejector 17 and a delivery pump 18 is arranged in a baffle 16. A deviation 19 fastened to the baffle 16 has a curve 21 arranged above a mixing tube 20 of the ejector 17. The deviation 19 directs the fuel delivered by the ejector 17 into the baffle 16. The deviation 19 has a latching connection 22 to the baffle 16.

1. A delivery unit mounted in a fuel tank, comprising a fuel pump arranged in a baffle and an ejector for delivering fuel into the baffle, the ejector having a mixing tube arranged essentially vertically, wherein a deviation for guiding fuel delivered by the ejector into the baffle is arranged at an outlet of the mixing tube of the ejector.

2. The delivery unit as claimed in claim 1, wherein the deviation further comprises a curve having one partial region being arranged above the outlet of the mixing tube and another partial region being arranged above the baffle.

3. The delivery unit as claimed in claim 1, wherein the deviation further comprises two curves adjacent to each other, the curves having regions adjacent to each other being arranged above the mixing tube and having free ends protruding laterally over the mixing tube.

4. The delivery unit as claimed in claim 1, wherein the deviation is arranged on the baffle.

5. The delivery unit as claimed in claim 1, wherein the deviation is arranged on the fuel pump.

6. The delivery unit as claimed in claim 1, wherein the deviation is designed as a separate component which is to be fastened to the fuel pump or to the baffle.

7. The delivery unit as claimed in claim 1, wherein the deviation forms a constructional unit with a component of the fuel pump.

8. The delivery unit as claimed in claim 1, wherein the deviation is manufactured in one piece with a component of the fuel pump.

9. The delivery unit as claimed in claim 1, wherein the mixing tube of the ejector is designed together with the fuel pump as a constructional unit which can be preassembled.

10. The delivery unit as claimed in claim 2, wherein the deviation is arranged on the baffle.

11. The delivery unit as claimed in claim 3, wherein the deviation is arranged on the baffle.

12. The delivery unit as claimed in claim 2, wherein the deviation is arranged on the fuel pump.

13. The delivery unit as claimed in claim 3, wherein the deviation is arranged on the fuel pump.

14. The delivery unit as claimed in claim 2, wherein the deviation is designed as a separate component which is to be fastened to the fuel pump or to the baffle.

15. The delivery unit as claimed in claim 3, wherein the deviation is designed as a separate component which is to be fastened to the fuel pump or to the baffle.

16. The delivery unit as claimed in claim 7, wherein the component is a fuel pump cover.

17. The delivery unit as claimed in claim 8, wherein the component is a fuel pump cover.

18. The delivery unit as claimed in claim 2, wherein the mixing tube of the ejector is designed together with the fuel pump as a constructional unit which can be preassembled.

19. The delivery unit as claimed in claim 3, wherein the mixing tube of the ejector is designed together with the fuel pump as a constructional unit which can be preassembled.

20. The delivery unit as claimed in claim 6, wherein the mixing tube of the ejector is designed together with the fuel pump as a constructional unit which can be preassembled.
